(19) United States
(12) Patent Application Publication
(10) Pub. No.: US 2016/0025262 A1
(43) Pub. Date: Jan. 28, 2016

(54) CORRUGATED SURFACE MOUNTING BRACKET

(71) Applicant: Vermont Slate & Copper Services, Inc., Morrisville, VT (US)

(72) Inventors: Brian Cecil Stearns, Stowe, VT (US); Alexander Grant Bornemann, Wolcott, VT (US)

(21) Appl. No.: 14/806,958

(22) Filed: Jul. 23, 2015

Related U.S. Application Data
(60) Provisional application No. 62/028,089, filed on Jul. 23, 2014.

(51) Int. Cl. F16M 13/02; H01Q 1/12; E01F 7/02; E04H 17/26; F16L 3/16; H02S 20/23

(52) U.S. Cl. CPC F16M 13/02; F16L 3/16; H02S 20/23; E01F 7/02; E04H 17/26; H01Q 1/12

(57) ABSTRACT

A mounting bracket is provided for attaching an object to a corrugated surface. The mounting bracket includes a first leg that, when assembled, is fixed to the corrugated surface. The mounting bracket includes a second leg, distinct and separate from the first leg, and when assembled, is fixed to the corrugated surface. The mounting bracket includes a main portion. The main portion is slidably engageable with the first leg and slidably engageable with the second leg. The main portion includes a plurality of teeth engageable with an aperture of the second leg.

### CROSS-REFERENCE TO RELATED APPLICATIONS

This application claims priority to co-pending U.S. Provisional Patent Application No. 62/028,089 filed on Jul. 23, 2014, the entire content of which is incorporated herein by reference.

### FIELD OF THE INVENTION

The present invention relates to brackets for mounting objects on structures. More specifically, the present invention relates to brackets for mounting objects to corrugated surfaces or rooftop structures.

### SUMMARY

The invention relates to mounting brackets for corrugated surfaces, such as rooftops, and the manner in which these brackets are assembled and installed. In some embodiments, the invention may relate to mounting solar panels, antennas, satellite dishes, snow fences, conduits, wiring, and the like.

Some embodiments of the invention provide a mounting bracket for attaching an object to a corrugated surface. The mounting bracket includes a first leg that, when assembled, is fixed to the corrugated surface. The mounting bracket includes a second leg, distinct and separate from the first leg, and when assembled, is fixed to the corrugated surface. The mounting bracket includes a main portion. The main portion is slidably engageable with the first leg and slidably engageable with the second leg. The main portion includes a plurality of teeth engageable with an aperture of the second leg.

Some embodiments of the invention further provide a mounting bracket for mounting an object to a corrugated surface. The mounting bracket includes a main portion including a channel at a first end, a flange at the second end, and a toothed region including a plurality of teeth. The mounting bracket further includes a first leg including a protrusion sized to engage the channel of the main portion, a first section connected to the corrugated surface, and a second section connecting the first section to the protrusion. The mounting bracket still further includes a second leg including a first section that, when assembled, is mated with the corrugated surface, and a second portion that defines an aperture sized to receive the flange of the main portion. The first leg is moveable with respect to the main portion about a first degree of adjustability via the pivoting engagement of the protrusion in the channel.

Some embodiments of the invention still further provide a method of assembling a mounting bracket on a corrugated surface including one or more undulations. A first leg, including a protrusion and a foot, is provided. A second leg, including an aperture and a foot, is provided. A main portion, including a channel and a toothed region including a plurality of teeth is provided. The foot of the first leg is attached to the corrugated surface. The protrusion of the first leg is slid into the channel of the main portion. The aperture of the second leg is slid over the toothed region of the main portion. The second leg is rotated such that the aperture contacts at least one of the plurality of teeth and the foot of the second leg is aligned with one of the undulations. The foot of the second leg is attached to the corrugated surface.

### BRIEF DESCRIPTION OF THE DRAWINGS

FIG. 1 is an exploded view of the mounting bracket.

FIG. 2 is a top view of the assembled mounting bracket.

FIG. 3 is a perspective view of the assembled mounting bracket.

FIG. 4 is a side view of the assembled mounting bracket.

FIG. 5 is a front view of the assembled mounting bracket.

FIG. 6 is a perspective view of a mounting bracket including a main portion secured to a first leg and positioned on a corrugated surface.

FIG. 7 is a perspective view of the mounting bracket with a second leg secured to the main portion.

FIG. 8 is a perspective view of the second leg in a locked position.

FIG. 9 is a perspective view of the assembled mounting bracket.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or object orientation (such as, for example, terms like “central,” “upper,” “lower,” “front,” “rear,” etc.) are only used to simplify description of embodiments of the present invention and do not alone indicate or imply that the device or element referred to must have a particular orientation. In addition, terms such as “first” and “second” are used herein for purposes of description and are not intended to indicate or imply relative importance or significance.

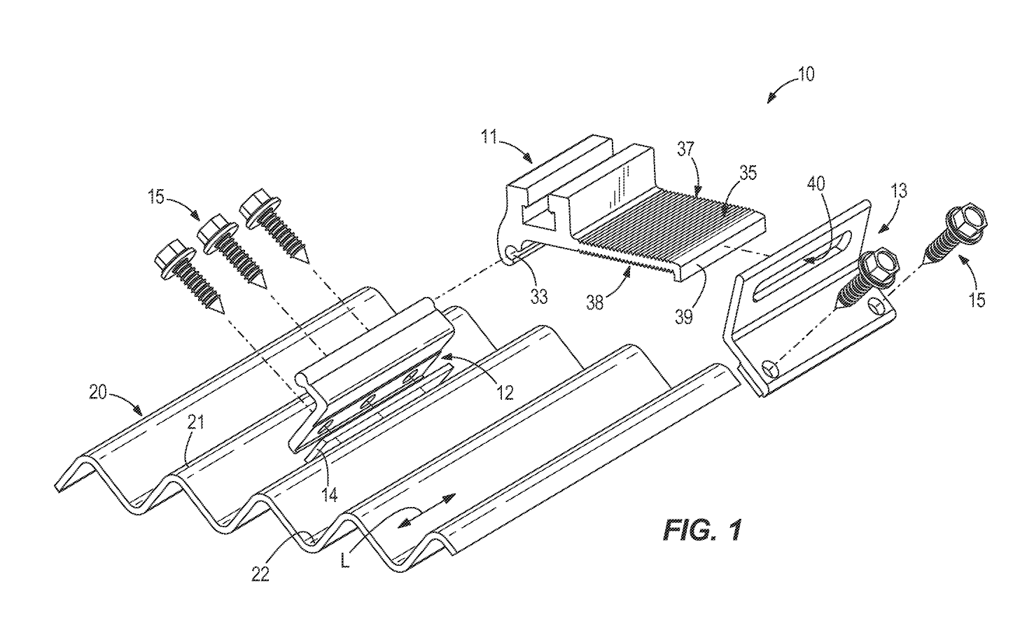

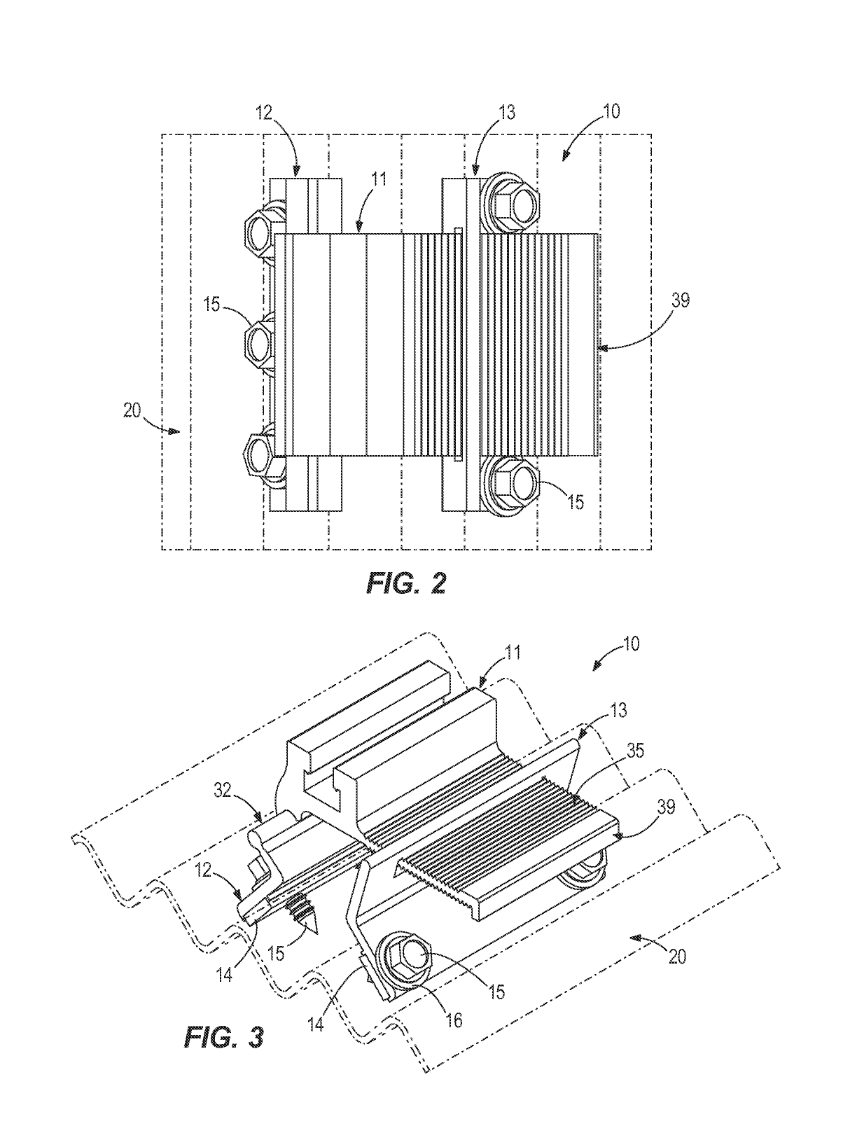

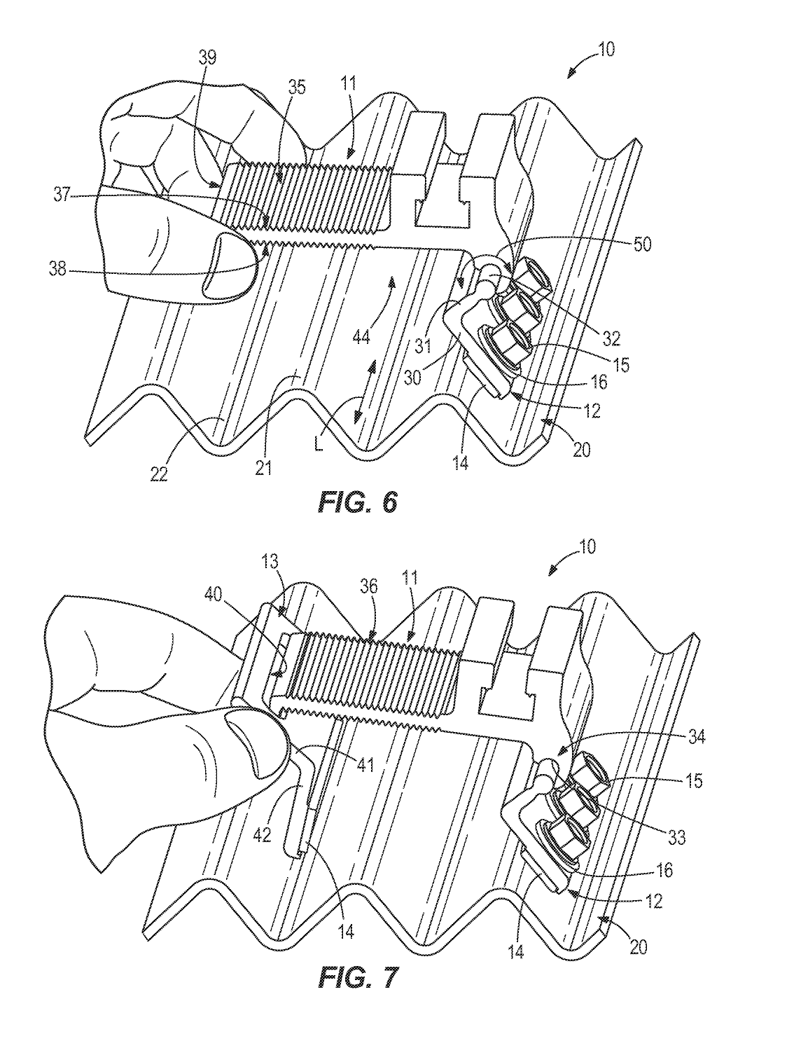

FIGS. 1-5 show the assembled system from various angles and perspectives. FIGS. 6-9 depict the steps involved with attaching a mounting bracket 10 to a corrugated surface 20. The corrugated surface 20 can be, for example, the roof of a house, garage, or shed. The illustrated corrugated surface 20 contains a number of alternating hills 21 and valleys 22 that extend in a first direction L, along the surface 20. The illustrated surface 20 is made from metal (e.g., steel, tin, aluminum, etc.). However, other non-metal materials such as fiberglass, can include one or more corrugations suitable for supporting the mounting bracket 10.

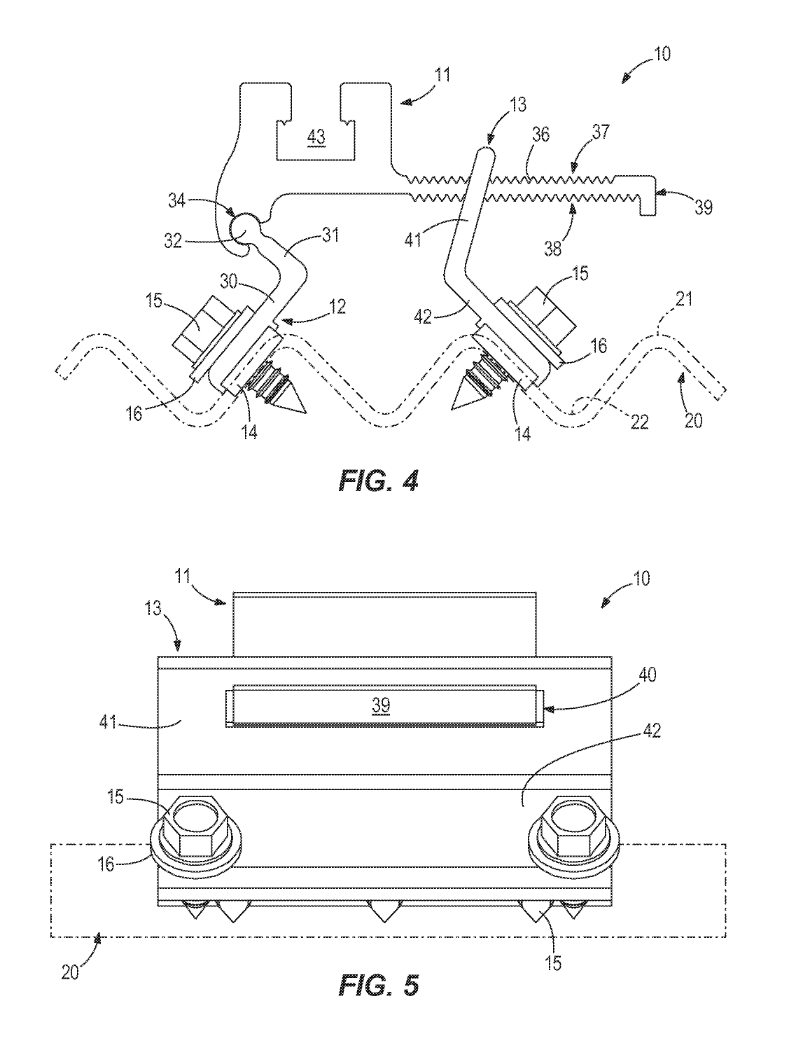

With reference to FIGS. 1-5, the illustrated mounting bracket 10 includes a main portion 11, a first leg 12, and a second leg 13. In the illustrated embodiment, the main portion 11 and the first and second legs 12, 13 are made of aluminum, but in other embodiments, the main portion 11 can include other metallic and/or non-metallic materials. The first leg 12 includes a first section or foot 30 that is securely mounted to the corrugated surface 20 with an elastomeric adhesive 14 as well as a plurality of screws 15. The elastomeric adhesive 14 can also form a waterproofing seal. The heads of the screws 15 are backed up by a washer 16 which can serve as an additional waterproofing seal. The washer 16 can be metal, elastomeric, or both. The illustrated first leg 12 also includes a second section 31 that is generally perpendicular to the first section 30 (as shown in FIG. 4) and includes a protrusion 32 that acts as first component of a hinge mechanism 34. As shown in FIGS. 1, 3, and 4, the protrusion 32 is generally cylindrical in shape.

The illustrated main portion 11 includes a channel 33 (FIG. 1) having a configuration similar to the cross-sectional shape of the protrusion 32 to allow for the protrusion 32 to slidingly mate with the channel 33. The engagement of the channel 33 with the protrusion 32 allows for a defined amount of rotational motion between the first leg 12 and the main portion 11. This defines a first degree of adjustability as indicated by arrow 50 (FIG. 6).

The illustrated main portion 11 also includes a toothed engagement region 35 having a series of parallel teeth 36 on opposing sides of the main portion 11 (FIGS. 1 and 4). The toothed engagement region 35 includes a top surface 37 which is generally facing away from the corrugated surface 20, and a bottom surface 38 which is generally facing towards the corrugated surface 20. Both the top surface 37 and bottom surface 38 include teeth 36 for proper engagement with the second leg 13. A downwardly depending flange 39 is located beyond the toothed engagement region 35 (opposite the channel 33), and extends generally perpendicular to the top and bottom surfaces 37, 38. The downwardly depending flange 39 may alternatively extend in an upward direction.

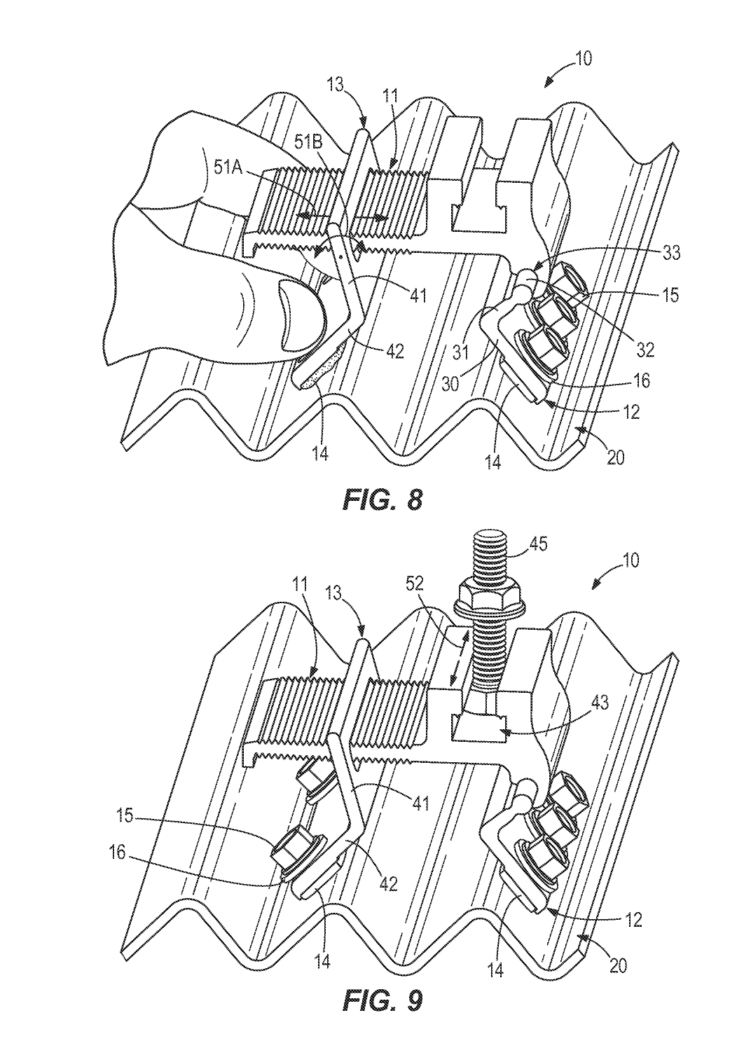

The second leg 13, as shown in FIGS. 1-5, includes a first section or foot 42 and a second section 41, generally perpendicular to the first section 42. An aperture 40 is located in the second section 41 and is sized to slide over the downwardly depending flange 39 (FIG. 7) and onto the toothed engagement region 35 of the main portion 11 along arrow 51A (FIG. 8). The aperture 40 may be smaller than the cross-sectional height of the flange 39 and may only be sized to slide over the flange 39 at an angle (FIG. 7). The aperture 40 is capable of traveling past one or more teeth 36 and engaging with any of the teeth 36 along the toothed engagement region 35 by tilting the second leg 13 forward or backwards about arrow 51B (FIG. 8), thereby placing it into a locked position. Aligning the second leg 13 with any of the number of teeth 36 and rotating relative to the teeth 36 defines a second degree of adjustability, as indicated by arrows 51A and 51B. The second degree of adjustability allows the first section 42 to come into contact with the corrugated surface 20 at an appropriate location, which can vary widely based on parameters (i.e. hill 21 and valley 22 height, angle and spacing) of the undulations of the corrugated surface 20. Similar to the first leg 12, the first section 42 of the second leg 13 is mounted to the corrugated surface 20 with an elastomeric adhesive 14 as well as a number of screws 15 and washers 16.

Located adjacent to the toothed engagement region 35 along the top surface 37 of the main portion 11 is a second channel, T-shaped channel, or T-slot 43 (a channel with the cross section of a ‘T’) which is open at both ends to accept at least one mounting bolt 45 for attaching various objects, such as solar panels. The mounting bolt 45 is slidably adjustable along the T-Slot 43 to permit adjustability along the direction indicated by arrow 52 (FIG. 9), defining the third degree of adjustability.

Some of the rooftop applications of the present invention can be, for example, solar panels, satellite dishes, antennas, and snow fences among other rooftop mounted structures. Many of the aforementioned rooftop objects or elements are designed to be affixed to a uniform surface, and therefore may have difficulties in attaching to a corrugated surface such as the corrugated surface 20. The mounting brackets 10 of the present invention are adjustable to accommodate various corrugated surfaces, as well as various rooftop object bolt patterns. Additionally, an adjustable air gap 44 can be provided between the bottom surface 38 of the mounting bracket 10 and the corrugated surface 20 (see FIG. 6). The adjustability in this air gap 44 allows a user to set various rooftop objects such as solar panels at an adequate height to permit proper cooling. The adjustable air gap 44 can also support and retain wires and other hardware needed for functioning of the roof mounted fixture.

To affix the mounting bracket 10 to a corrugated surface 20, the areas of the corrugated surface 20 where the elastomeric adhesive 14 is to be placed must first be cleaned. Any dirt, rust, or debris may decrease the effective adhesion. Once clean, the adhesive 14 of the first foot 30 is pressed firmly against the corrugated surface 20 to attach the foot 30 of the first leg 12 to the corrugated surface 20, as shown in FIG. 6. In addition to the adhesive 14, screws 15 (e.g., sheet metal screws) and washers 16 firmly retain the first foot 30 on the corrugated surface 20.

The main portion 11 is then slidably attached to the first leg 12 via the hinge mechanism 34. As shown, the protrusion 32 of the first leg 12 slides into the channel 33 formed in the main portion 11. Then, the main portion 11 is allowed a limited amount of rotation about the hinge mechanism 34 defined as the first degree of adjustability, indicated by arrow 50 (FIG. 6). An aperture 40 of the second leg 13 is slid over the downwardly depending flange 39 (FIG. 7) and the toothed engagement region 35 (FIG. 8) of the main portion 11. The main portion 11 is slidably engageable with the first leg 12 in a first direction and slidably engageable with the second leg 13 in a second direction transverse to the first direction. The second leg 13 is rotated such that the aperture 40 contacts at least one of the teeth 36. A suitable tooth 36 is chosen dependent on how the elastomeric adhesive 14 of the second foot 42 lines up with an undulation of the corrugated surface 20 when the second foot 42 is placed into the locked position. Once an optimal location is chosen, the elastomeric adhesive 14 on the second foot 42 is pressed into the corrugated surface 20. In addition to the adhesive 14, screws 15 (e.g., sheet metal screws) and washers 16 firmly retain the second foot 42 on the corrugated surface 20. This inhibits the second leg 13 from moving with respect to the corrugated surface 20, and therefore also inhibits all movement of the second leg 13 relative to the first leg 12 and the main portion 11.

Then, at least one mounting bolt 45 is slid into the T-Slot 43 (FIG. 9) and adjusted along the T-Slot 43 to allow for the desired object to be mounted on the mounting bracket 10. An object or element is mounted and secured to the mounting bracket via the bolt 45. A single mounting bracket 10 may be used, or multiple mounting brackets 10 may be used in conjunction with one another to mount an element with multiple mounting points. Additionally, any number of mounting brackets 10 can be used in conjunction with any other suitable mounting structures or methods.

What is claimed is:

1. A mounting bracket for attaching an object to a corrugated surface, the mounting bracket comprising:
a first leg that, when assembled, is fixed to the corrugated surface;
a second leg, distinct and separate from the first leg, and, when assembled, is fixed to the corrugated surface, the second leg including an aperture; and
a main portion,
wherein the main portion is slidably engageable with the first leg and slidably engageable with the second leg, and
wherein the main portion includes a plurality of teeth engageable with the aperture of the second leg.

2. The mounting bracket of claim 1, further comprising:
a bolt configured to mate with the object;
wherein the main portion further includes a first channel configured to slidably engage with the first leg, and a second channel configured to slidably receive the bolt.

3. The mounting bracket of claim 2, wherein the second channel is a T-shaped channel.

4. The mounting bracket of claim 1, wherein the main portion is slidably engageable with the first leg in a first direction and slidably engageable with the second leg in a second direction transverse to the first direction.

5. The mounting bracket of claim 1, wherein the main portion further includes a flange and the aperture is sized to receive the flange.

6. The mounting bracket of claim 1, wherein the main portion includes a first surface and a second surface opposite the first surface, wherein the plurality of teeth are positioned on at least a portion of the first surface and at least a portion of the second surface.

7. The mounting bracket of claim 1, wherein the first leg includes a first foot and the second leg includes a second foot, and, when assembled, the first foot and the second foot are fixed to the corrugated surface.

8. The mounting bracket of claim 7, wherein the first foot and the second foot are fixed to the corrugated surface with one or both of an adhesive and a bolt.

9. The mounting bracket of claim 1, wherein the object is one of a solar panel, a satellite dish, an antenna, wiring, and a snow fence.

10. A mounting bracket for mounting an object to a corrugated surface, the mounting bracket comprising:
a main portion that includes a channel at a first end, a flange at a second end, and a toothed region including a plurality of teeth between the first end and the second end;
a first leg including a protrusion sized to engage the channel of the main portion, a first section sized to engage to the corrugated surface, and a second section extending between the first section and the protrusion; and
a second leg including a first section that is sized to engage the corrugated surface, and a second portion defining an aperture that is sized to receive the flange of the main portion, wherein the protrusion is pivotable within the channel to permit the first leg to pivot with respect to the main portion about a first degree of adjustability.

11. The mounting bracket of claim 10, wherein the aperture is also sized to receive the toothed region of the main portion, such that the first section of the second leg is pivotable with respect to the main portion about a second degree of adjustability while edges of the aperture engage any of the plurality of teeth of the toothed region.

12. The mounting bracket of claim 10, wherein an angle of the first leg with respect to the main portion and an angle of the second leg with respect to the main portion are adjustable to accommodate for different sizes, shapes and configurations of the corrugated surface.

13. The mounting bracket of claim 10, further comprising:
a bolt configured to mate with the object,
wherein the channel is a first channel, the main portion further comprising a second channel configured to slidably receive the bolt.

14. The mounting bracket of claim 10, wherein the main portion is slidably engageable with the first leg in a first direction and slidably engageable with the second leg in a second direction transverse to the first direction.

15. The mounting bracket of claim 10, wherein the main portion includes a first surface and a second surface opposite the first surface, wherein the plurality of teeth are positioned on at least a portion of the first surface and at least a portion of the second surface.

16. The mounting bracket of claim 10, wherein the object is one of a solar panel, a satellite dish, an antenna, or a snow fence.

17. A method of assembling a mounting bracket on a corrugated surface including one or more undulations, the method comprising:
attaching a first foot of a first leg to the corrugated surface;
sliding a protrusion of the first leg into a channel of a main portion;
inserting a toothed region of the main portion into an aperture of a second leg;
rotating the second leg such that the aperture contacts at least one of a plurality of teeth and a second foot of the second leg is aligned with one of the one or more undulations; and
attaching the second foot to the corrugated surface.

18. The method of claim 17, wherein the channel is a first channel, the method further comprising:
providing an object to mount to the corrugated surface via the mounting bracket;
sliding a bolt into a second channel; and
securing the object to the mounting bracket via the bolt.

19. The method of claim 17, wherein the toothed region of the main portion is located between the channel and a flange, wherein inserting the toothed region of the main portion into the aperture of the second leg further includes inserting the flange into the aperture of the second leg.

20. The method of claim 17, wherein attaching the foot of the second leg to the corrugated surface further includes locking the main portion relative to the first leg and the second leg such that the main portion is fixed relative to the corrugated surface.
